(19) United States
(12) Patent Application Publication
(10) Pub. No.: US 2014/0136560 A1
(43) Pub. Date: May 15, 2014

(54) SYSTEM AND METHOD FOR SELECTING THE RECOMMENDED SIZE OF AN ARTICLE OF CLOTHING

(71) Applicant: SIZE SECRET INC., Los Angeles, CA (US)

(72) Inventor: SHAWN GOLSHANI, Encino, CA (US)

(73) Assignee: SIZE SECRET INC., Los Angeles, CA (US)

(21) Appl. No.: 13/678,481

(22) Filed: Nov. 15, 2012

(51) Int. Cl. G06F 17/30

(52) U.S. Cl. CPC G06F 17/30386
USPC 707/758

(57) ABSTRACT

The system provides the recommended fitting size of clothing. A first set of body dimensions including height, weight, and waist size; and, information regarding a selected article of clothing having a defined set of article dimensions are obtained. A first module computes a second set of human body dimensions. This module includes a first mathematical model generated by a statistical analysis of a human anthropometric database. A second module is configured to compute a recommended fitting size based on: 1) the first set of human body dimensions; 2) the second set of human body dimensions; and, 3) the defined set of article dimensions. This second module includes a data base containing clothing related look up tables for use in computing the recommended fitting size for the particular article of clothing. The second set of human body dimensions includes neck size for a clothing top, and pants size for a bottom.

### BACKGROUND OF THE INVENTION

1. Field of the Invention

The present invention relates generally to clothing recommendation systems, and more particularly to an online system for providing clothing size recommendations based on user inputs.

2. Description of the Related Art

While industries such as computer related industries typically sell around 50% of their yearly sales online and book sellers sell about 40% of their sales online, online sales of apparel and footwear comprises only 10% of total industry sales due to a few factors but primarily is due to the difficulty in sizing. Consumers are fearful of buying clothing they cannot try on because they are not certain that the clothes will fit them well. But what if the consumer knew that he could easily find clothing that fits him well online without trying it on for size? Some inefficient solutions to the problem of shopping for clothes online without trying the clothes on include 3D body scanners and virtual fitting rooms. The problem with 3D body scanners is that the consumer has to travel to a specific location to get body scanned and then upload his scanned information online, which is not compatible with most shopping sites. The problem with virtual fitting rooms is that a cartoon or avatar representation of the consumer is inaccurate and difficult to work with when it comes to sizing. Another solution to sizing clothing online is to ask the user which brands and fits already fit the user best and then to estimate which other similar fitting brands might fit the user. The problem with this solution of cross matching various brands is several fold. First, it is noted that the cut, fit, and size of the items within a clothing brand constantly changes without a universal or uniform guide. Second, different materials stretch, shrink, and fit differently even within the same products over time and in different environments. Third, the user cannot easily and accurately find the best size for the user or which brands fit the body of the user best because of the lack of accuracy, precision, and unaccounted variables of this inefficient method. A prime reason that people return clothing purchased from the internet is inaccurate sizing, in fact 60% of online sales are fit related. Another prime reason is that people purchase multiple sizes of the same item, try them on, and return the products that don't fit. This process creates a net loss for the businesses and the economy. Every clothing company has a different size chart or set of measurement sizes for each of their items which convolutes the consumer's ability to understand what size he is. This complicated and inefficient system of sizing creates a demand for a solution that can provide for accurate sizing. Also, international standards and systems for measurement make the problem worse. Also, each brand is designed to fit a particular body type best but consumers do not know which brands fit them best.

There are numerous patents that have issued that have involved determining clothing sizes. These include:

U.S. Pat. No. 6,711,455, entitled “Method For Custom Fitting of Apparel,” issued to Holloway et al., discloses a method for custom fitting an article to a human being having the steps of defining a first set of human body dimensions to be reported by the human being, defining a second set of human body dimensions to be inferred from said first set of human body dimensions, providing a first mathematical model relating said second set of human body dimensions to said first set of human body dimensions, wherein said mathematical model has been generated by statistical analysis of a human anthropometric database, obtaining a first set of values of said first set of body dimensions by report of the human being, computing a second set of values of said second set of human body dimensions from said first set of values of said first set of human body dimensions by using said first mathematical model, defining a set of article dimensions, providing a second mathematical model relating said article dimensions to said first set of human body dimensions and said second set of human body dimensions, computing a third set of values of said set of article dimensions from said first set of values of said first set of human body dimensions and said second set of values of said second set of human body dimensions by using said second mathematical model.

U.S. Pat. No. 6,353,770, entitled “Apparatus and Method For the Remote Production of Customized Clothing,” issued to Ramsey et al., discloses an apparatus and method is provided for creating custom-fitted garments wherein the customer provides critical information which is known to or easily ascertainable by the customer without assistance. Using this critical information, a controller applies rules contained in a model to estimate other critical dimensions necessary for the production of a selected garment, and which are not easily ascertainable directly by the customer without assistance. Using the actual and estimated critical dimensions, the controller determines the pattern data which is used to produce custom-made clothing which provides a superior fit to that which a customer would typically experience from the retail purchase of a similar mass-produced garment.

U.S. Pat. Publcn. No. 20040093105, entitled “Method for Custom Fitting of Apparel,” to Holloway, Robert Gordon Ernest et al., discloses a method for custom fitting an article to a human being having the steps of defining a first set of human body dimensions to be reported by the human being, defining a second set of human body dimensions to be inferred from said first set of human body dimensions, providing a first mathematical model relating said second set of human body dimensions to said first set of human body dimensions, wherein said mathematical model has been generated by statistical analysis of a human anthropometric database, obtaining a first set of values of said first set of body dimensions by report of the human being, computing a second set of values of said second set of human body dimensions from said first set of values of said first set of human body dimensions by using said first mathematical model, defining a set of article dimensions, providing a second mathematical model relating said article dimensions to said first set of human body dimensions and said second set of human body dimensions, computing a third set of values of said set of article dimensions from said first set of values of said first set of human body dimensions and said second set of values of said second set of human body dimensions by using said second mathematical model.

U.S. Pat. Publcn. No. 20110055054, entitled “METHOD FOR ONLINE SELECTION OF ITEMS AND AN ONLINE SHOPPING SYSTEM USING THE SAME,” to Holloway, Robert Gordon Ernest et al., discloses a method for facilitating an online selection of an item by a user is described. The item is selected out of a plurality of selection items of different sizes, the selection being based on a reference item located remotely from the plurality of selection items. The method is performed on an electronic system and starts with accessing data related to a first image of the reference item, and at least one known first reference measurement associated with the first image. Data is then accessed related to one or more second images of one or more selection items, and at least one known second reference measurement associated with each of the second images. The data associated with the first and second images is then processed so as to facilitate dimensional comparison of the reference item with at least one of the selection items. Finally, the user is enabled to visually compare at least one dimension of the at least one of the selection items, with a corresponding dimension of the reference item, the result of the comparison enabling the user to select an item out of the plurality of selection items.

U.S. Pat. Publcn. No. 20110218876, entitled “ONLINE SYSTEM AND METHOD FOR BRA RECOMMENDATIONS,” to Sorrento, discloses an online bra recommendation system and method provide one or more customer specific size and style recommendations. The recommendations are based on a calculated customer specific bra size and one or more customer style preferences. The calculated customer specific bra size is based on customer measurements. The customer measurements may include a measurement above the bust, around the fullest part of the bust and around the ribcage, under the bust. The customer may be instructed as to how to take appropriate measurements. The recommendation may further be based on feedback regarding current bra size and fit issues. The recommendation may further be based on one or more feature selections. The information may be collected through an online system, the recommendation made by a professional and the recommendation communicated to the user through the online system.

### SUMMARY OF THE INVENTION

In one broad aspect, the present invention is embodied as a system for selecting the recommended fitting size of an article of clothing for a user, the article of clothing being a clothing top. Capturing means is configured to: 1) obtain a first set of human body dimensions comprising height, weight, and waist size; and, 2) obtain a selected particular article of clothing having a defined set of article dimensions. A first module is configured to compute a second set of human body dimensions from the first set of human body dimensions. The first module includes a first mathematical model generated by a statistical analysis of a human anthropometric database. The second set of human body dimensions comprises neck size. A second module is configured to compute a recommended fitting size based on: 1) the first set of human body dimensions; 2) the second set of human body dimensions; and, 3) the defined set of article dimensions. The second module includes a data base containing article of clothing related look up tables for use in computing the recommended fitting size for the particular article of clothing. Communication means is operatively connected to the second module configured to provide the recommended fitting size to a user.

In another broad aspect, the present invention is embodied as a system for selecting the recommended fitting size of an article of clothing for a user, the article of clothing being a clothing bottom. Capturing means is configured to: 1) obtain a first set of human body dimensions comprising height, weight, and waist size; and, 2) obtain a selected particular article of clothing having a defined set of article dimensions. A first module is configured to compute a second set of human body dimensions from the first set of human body dimensions. The first module includes a first mathematical model generated by a statistical analysis of a human anthropometric database. The second set of human body dimensions comprises pants size. A second module is configured to compute a recommended fitting size based on: 1) the first set of human body dimensions; 2) the second set of human body dimensions; and, 3) the defined set of article dimensions. The second module includes a data base containing article of clothing related look up tables for use in computing the recommended fitting size for the particular article of clothing. Communication means is operatively connected to the second module configured to provide the recommended fitting size to a user.

The present invention involves calculation of body dimensions based on information that the consumer already knows about himself/herself, i.e. height, weight, and waist. This is a very efficient and easy to use tool which is compatible with most online shopping providers.

### BRIEF DESCRIPTION OF THE DRAWINGS

FIG. 1 is a schematic illustration of a preferred embodiment of the system for selecting the recommended size of an article of clothing for a user, showing the relationship between the user and a third party affiliate.

FIG. 2 is an example screen shot of a user interface for the system of the present invention.

FIGS. 3A-3D (Prior Art) include tables from pages 234 and 235 of the 1988 Anthropometric Survey of U.S. Army Personnel: Methods and Summary Statistics. FIG. 3A (Prior Art) is a table showing the percentiles of the circumference of the base of the neck, as distinguished for females and males. FIG. 3B (Prior Art) is a table showing a summary of the statistical analysis for the females of FIG. 3A. FIG. 3C (Prior Art) is a table showing a summary of the statistical analysis for the males of FIG. 3A. FIG. 3D (Prior Art) is a Frequency Table showing the frequency distribution.

FIGS. 4A-4D (Prior Art) include tables from pages 182 and 183 of the 1988 Anthropometric Survey. FIG. 4A (Prior Art) is a table showing the percentiles of the functional leg length, as distinguished for females and males. FIG. 4B (Prior Art) is a table showing a summary of the statistical analysis for the females of FIG. 4A. FIG. 4C (Prior Art) is a table showing a summary of the statistical analysis for the males of FIG. 3A. FIG. 3D (Prior Art) is a Frequency Table showing the frequency distribution.

The same elements or parts throughout the figures of the drawings are designated by the same reference characters, while equivalent elements bear a prime designation.

### DETAILED DESCRIPTION OF THE INVENTION

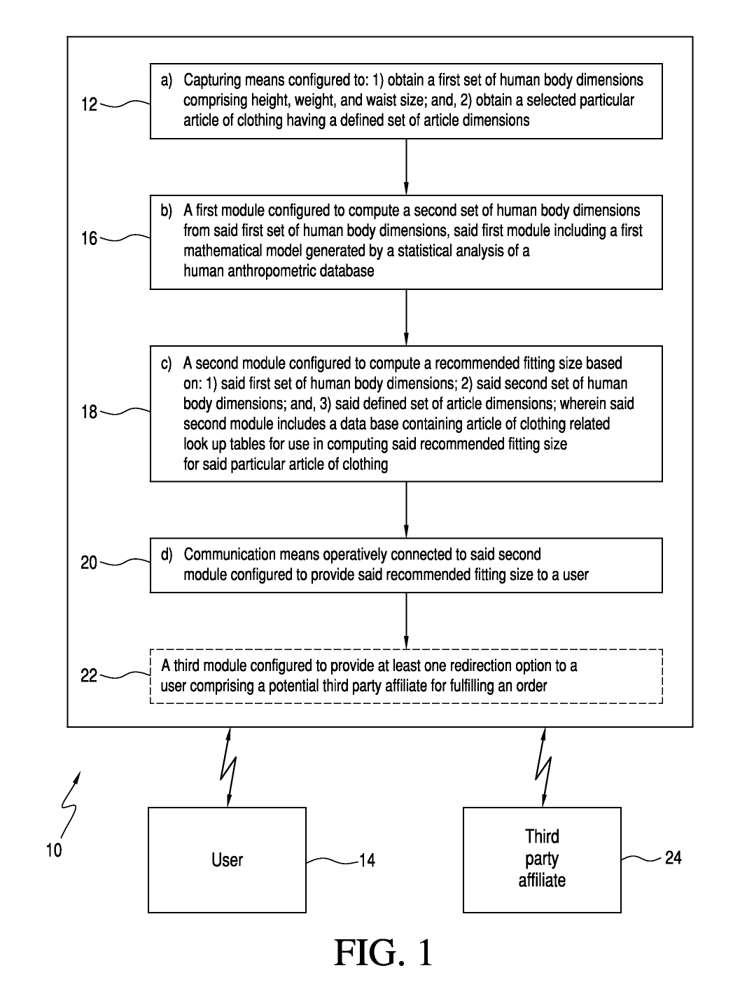

Referring now to the drawings and the characters of reference marked thereon, FIG. 1 illustrates the system for selecting the recommended fitting size of an article of clothing for a user, designated generally as 10. The system 10 includes capturing means 12 for: 1) obtaining a first set of human body dimensions; and, 2) obtaining a selected particular article of clothing having a defined set of article dimensions. The first set of human body dimensions includes at least height, weight, and waist size. In a preferred embodiment this first set of human body dimensions comprises solely height, weight, and waist size.

There are numerous ways a system operator can capture necessary information from a consumer/user 14 interested in purchasing apparel, both remotely and in-store. Remotely, the interested consumer can access a retailer's web site through a computer, a PDA, a web enabled phone, interactive television, or any other electronic medium used to access the Internet. Furthermore, such capturing means may include a standalone device such as a computer, PDA, mobile phone, interactive television, or touchscreen device that can capture this information. Also remotely, the interested consumer can call a retailer's customer service or ordering center, or they could send a fax or use any form of mail. In a store environment, the interested consumer could either provide the information directly to an employee of the retailer, or use any self-service device in the store such as a kiosk, Internet terminal or customer service telephone.

In a preferred embodiment, the potential consumer would log on to the retailer's web site. This website has non-custom made products. The consumer would select the product category in which he is interested, for example, a pair of pants, a pair of jeans, a sweater, a skirt, a dress, a shirt, a blouse, a vest, a jacket, a coat, a pair of leggings, a jersey, a pair of shorts, a leotard, a pair of underwear, a hat, a cap, and/or a swimming or bathing suit. Once he has selected the product category, then he begins to filter the results to find a particular item that best matches his preferences. Thus, he would select a particular article of clothing having a defined set of article dimensions. For example, in the case of pants, he could browse a number of different types of pants and choose the pair of pants that best matches the user's preferences. User's preferences may include, for example, sale items, color, designer, store or vendor, price, size, popular, and/or brand. The interested consumer/user would also input the first set of human body dimensions, i.e. his/her height, weight, and waist size. This information is collected by the system 10.

The system 10 includes a first module 16 for computing a second set of human body dimensions from the first set of human body dimensions. In the case of a clothing top the second set of human body dimensions comprises neck size. Additionally, it may include chest size, shoulder size, stomach size, and/or sleeve size. The second module is also a computer-based subsystem. As used herein the term “clothing top” is defined broadly to include, for example, a shirt, t-shirt, button down shirt, polo shirt, blouse, long sleeve shirt, sleeveless shirt, tank top, spaghetti strap, tube top, jacket, coat, blazer, trench coat, pea coat, dress, sweater, pull over sweater, zip up sweater, hoody, turtle neck, vest, cardigan, hat, scarf, and/or gloves.

In the case of a clothing bottom, the second set of human body dimensions comprises pants size. Additionally, it may include, for example, shoe size and underwear size. As used herein the term “clothing bottom” is defined broadly to include, for example, pants, shorts, jeans, skirt, shoes, and/or socks.

The first module 16 includes a first mathematical model generated by a statistical analysis using different mathematical functions such as a regression model of a human anthropometric database. In the preferred embodiment, the first mathematical model 16 contains formulas that relate various dimensions of the human body to one another, and are used to infer body dimensions that are not reported by the consumer from those that are reported by the consumer. In the most preferred embodiment, this first part of the model is derived by statistical analysis of the “1988 Anthropometric Survey of U.S. Army Personnel: Methods and Summary Statistics”, by CLAIRE C. GORDON ET. AL., September 1989, Technical Report Natick/TR-89/044, United States Army Natick Research, Development and Engineering Center, Natick, Massachusetts, although in other embodiments the data in the U.S. Army database may be supplemented by body measurements of other individuals. The 1988 Anthropometric Survey of U.S. Army Personnel: Methods and Summary Statistics is incorporated by reference herein in its entirety. In another embodiment the human anthropometric database also includes the Civilian American and European Surface Anthropometry Resource (CAESAR).

A second module 18 computes a recommended fitting size based on: 1) the first set of human body dimensions; 2) the second set of human body dimensions; and, 3) the defined set of article dimensions. The second module 18 includes a data base containing article of clothing related look up tables for use in computing said recommended fitting size for said particular article of clothing. The second module 18 is a computer-based subsystem. Once the system calculates the unreported body dimensions and the user has selected a specific article of clothing, the system selects the best size for the user given the defined article dimensions of the specific article of clothing. For example, if the user has a neck size of 16 inches and the user selects a T-shirt in which the size Medium is made for a user with a size 16 then the system would recommend the user to select size medium. In the case that the user has body dimensions that are not a perfect match with the defined article dimensions, then the system would recommend the closest fitting size. For example, if the user has a size 16 neck and the article dimensions are 14 for Medium and 17 for Large, then the system would recommend a size Large to the user.

Communication means 20, also a computer-based subsystem, provides the recommended fitting size to the user. Conventional hardware/software communication means may be utilized. Typically, the communication means is incorporated within or operatively associated with the capturing means. Communication means 20 is operatively connected to the second module.

In one embodiment the system 10 further includes a third module 22 for providing at least one redirection option to a user. The redirection option would be a potential third party affiliate 24 for fulfilling an order. In this embodiment, this redirection option is provided simultaneously with the recommended fitting size. The third party affiliate may be, for example, an online store that engages in the business of selling, stocking, and shipping clothing. Other examples may include a “brick and mortar” store. Another embodiment can be for the self-fulfillment of online orders but a particular retailer in which the user would shop directly from a store and not need to be redirected to a new webpage. In another embodiment the third module is configured to fulfill the order within a partner's website, store, or application without redirection. The business relationship with a specified partner using the technology within their own website, store, or application can be that of a licensee or subscriber.

The system 10 may be embodied in a conventional computer system for online communications to other computer systems, including smart phones, tablets, laptops, desktops, etc.

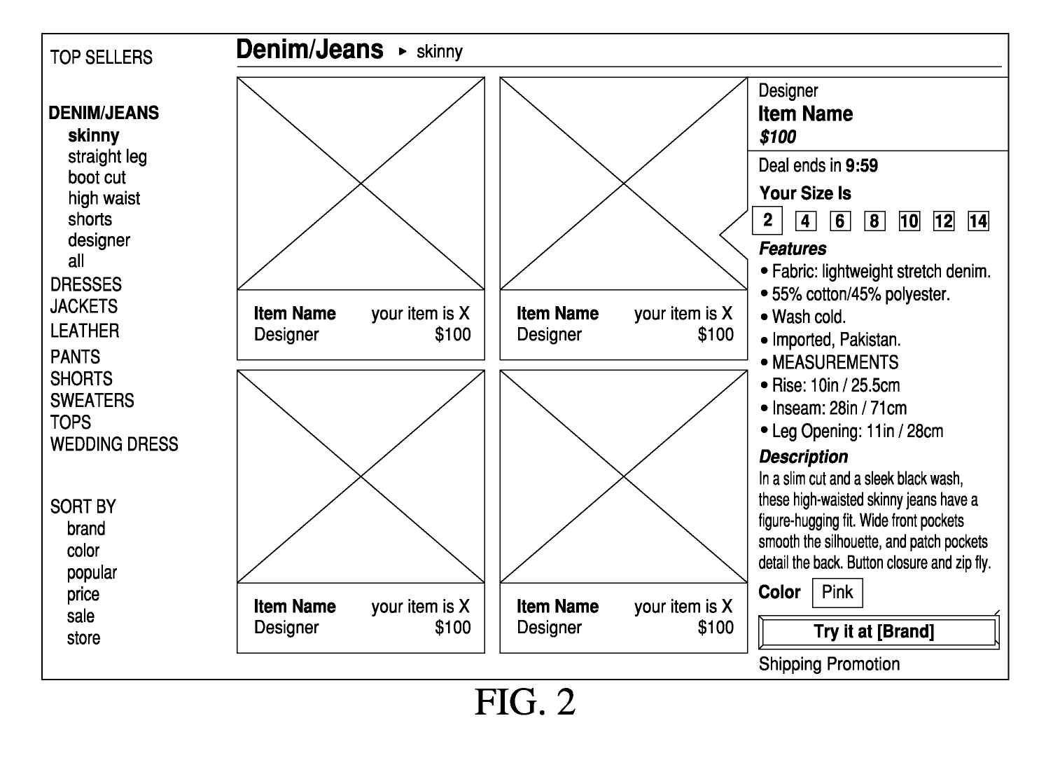

To recap the process we note that the user first inputs his known body measurements, including at least height, waist, and waist size. Next the user selects what articles of clothing he wishes to browse, e.g. t-shirts, dresses, pants. Next, the user sees a list of possible articles of clothing to buy with item specific information such as the price and recommended size. Next, once the user hovers over or selects a particular item of clothing, the system provides detailed information to the user like the recommended size, the color, the price, the store that is selling it, a set of features of the item, and/or description of the item. Any item specific information can be displayed in the hover over window in order to provide more details to the user than what he already sees in the previous browsing window. Referring now to FIG. 2, a sample screen shot of what the user will see once the system recommends to the user what size fits him the best, is illustrated. Next, in the case that the user is browsing the items of a third party or third parties, the user is redirected to the store that can fulfill the user's order after the user clicks on the item specific information or the “call to action” button of the particular item.

Another similar process is when the user is at the brick and mortar store location of a retail store. In such an instance, in one embodiment, the user would go through the same process mentioned above on his mobile device so that he does not need to try on clothes to find his right size. The user can scan or take a picture of the bar code of the item. Instead of purchasing the clothing on his device, he would be told what size he is, in a specific item at the retail store, and then proceed to find and pay for that particular item while at the store location. In another embodiment, the user would approach an in-store kiosk, or the like, and receive an in-store recommendation without the requirement of utilizing his mobile device.

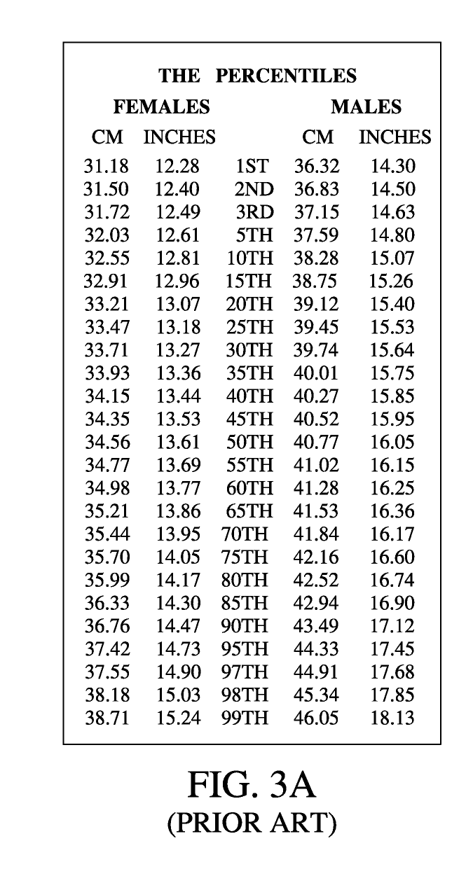

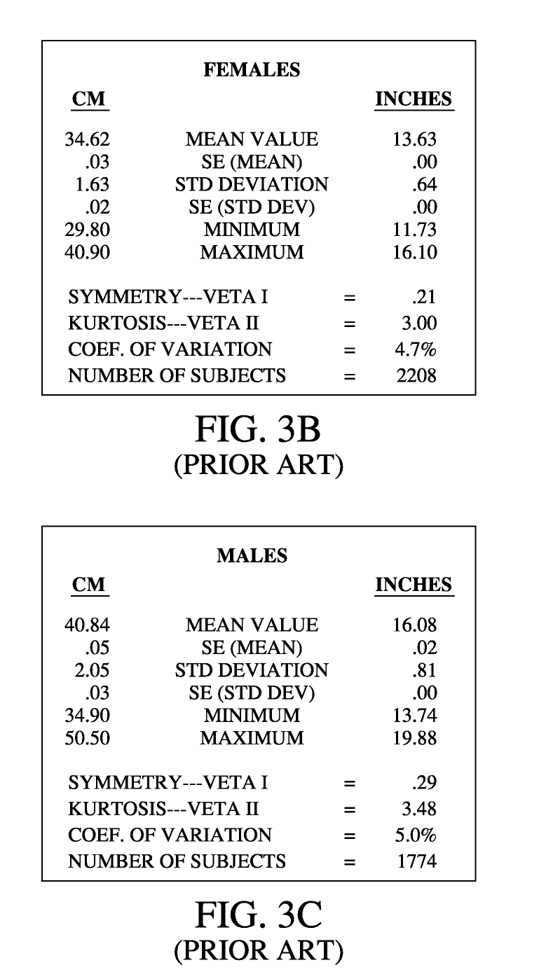

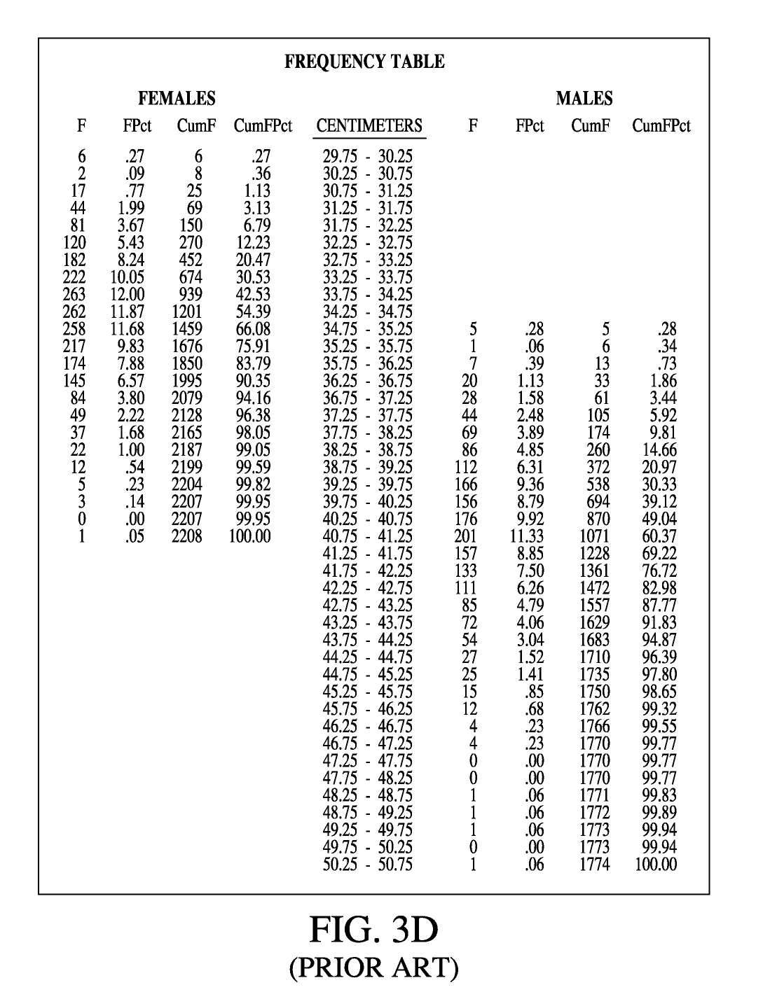

FIGS. 3A-3D include tables from pages 234 and 235 of the 1988 Anthropometric Survey of U.S. Army Personnel: Methods and Summary Statistics, discussed above. These tables include statistical data regarding the circumference of the base of the neck. The circumference of the base of the neck is measured by a tape passing over drawn lateral and anterior neck landmarks (i.e. below the Adam's apple). The subject stands erect with the head in the Frankfort plane, i.e. erect with the head looking straight. The shoulders and upper extremities are relaxed. FIG. 3A (Prior Art) is a table showing the percentiles of the circumference of the base of the neck, as distinguished for females and males. FIG. 3B (Prior Art) is a table showing a summary of the statistical analysis for the females of FIG. 3A. FIG. 3C (Prior Art) is a table showing a summary of the statistical analysis for the males of FIG. 3A. FIG. 3D (Prior Art) is a Frequency Table showing the frequency distribution.

The neck size percentiles of FIG. 3A correspond to the height, weight, and waist of approximately 4000 users allowing, under the principles of the present invention, the inference of the dependent variable of neck size based on the independent variables of height, weight, and waist. As mentioned above, this inference can be drawn by a statistical analysis using different mathematical functions such as a regression model of this human anthropometric database. A similar method may be applied to calculate the measurements of chest size, shoulder size, stomach size, and sleeve size, respectively.

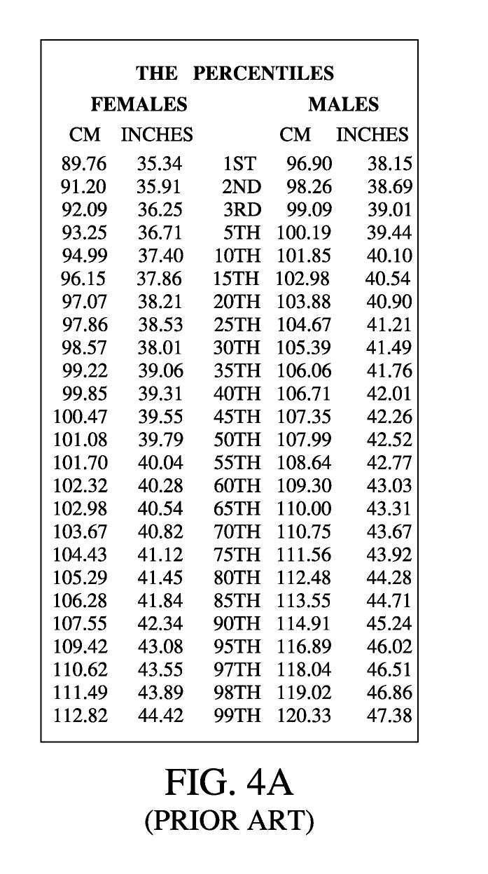

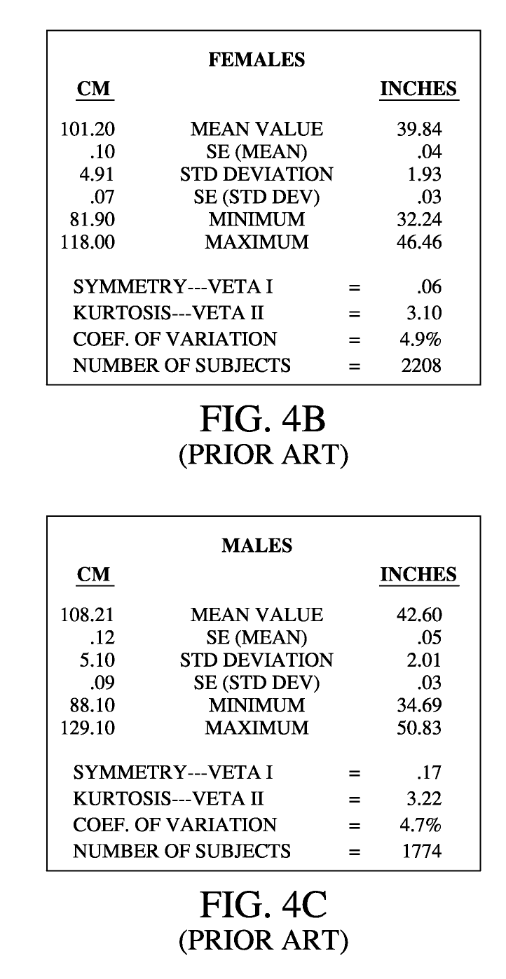

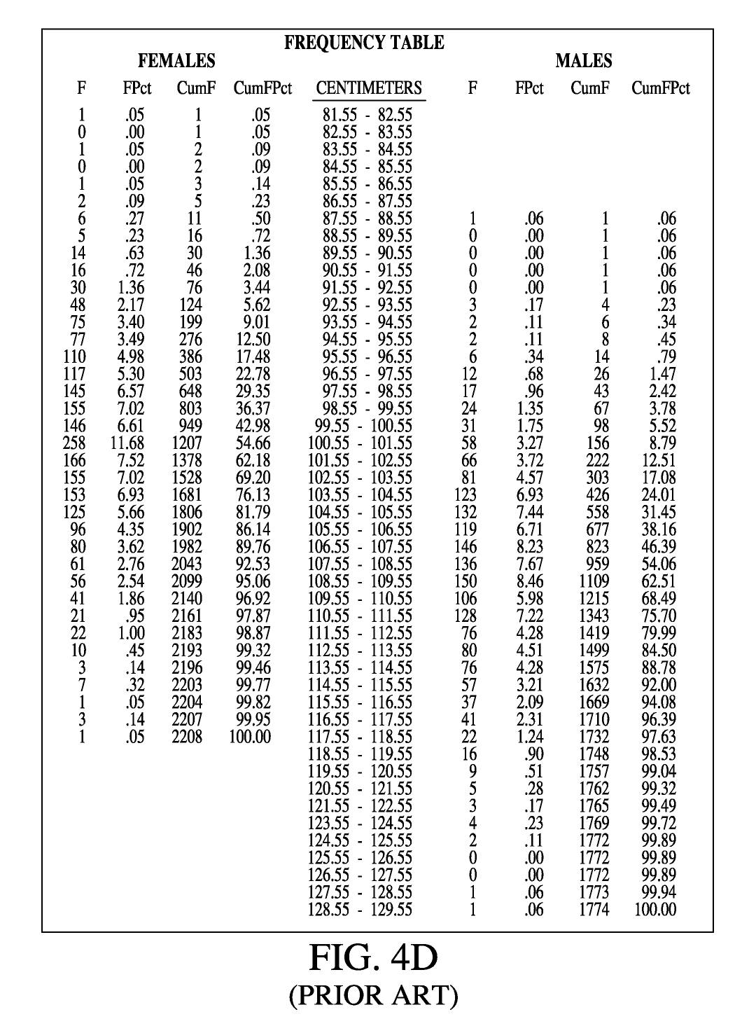

FIGS. 4A-4D include tables from pages 182 and 183 of the 1988 Anthropometric Survey. These tables include statistical data regarding the functional leg length. The straight-line distance between the plane of the bottom of the right foot with the leg extended and the back of the body of a seated subject is measured with an anthropometer passing over the trochanter landmark on the side of the hip. The subject sits erect on a stool 40.8 cm high. The right leg is extended and the foot is on the base plate of the anthropometer, which rests on the floor. The measurement is made from the footrest surface of the base plate. When the leg is extended straight, the line distance between the bottom of the foot to the top of the hip joint is the same as the distance between the ankle and the waist point and is measured with a tape.

FIG. 4A (Prior Art) is a table showing the percentiles of the functional leg length, as distinguished for females and males. FIG. 4B (Prior Art) is a table showing a summary of the statistical analysis for the females of FIG. 4A. FIG. 4C (Prior Art) is a table showing a summary of the statistical analysis for the males of FIG. 3A. FIG. 3D (Prior Art) is a Frequency Table showing the frequency distribution.

Similar to the discussion above regarding the neck size, the functional leg length percentiles of FIG. 4A correspond to the height, weight, and waist of the approximately 4000 users in this survey allowing, under the principles of the present invention, the inference of the dependent variable of pant size based on the independent variables of height, weight, and waist. As mentioned above, this inference can be drawn by a statistical analysis using different mathematical functions such as a regression model of this human anthropometric database. A similar method may be applied to calculate the measurements of shoe size and underwear size, respectively.

The foregoing detailed description has set forth embodiments of the systems and/or processes via the use of a flowchart and/or examples. Insofar as such flowchart and/or examples contain one or more functions and/or operations, it will be understood by those within the art that each function and/or operation within such flowchart, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software/and or firmware would be well within the skill of one skilled in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communication link, a wireless communication link (e.g., transmitter, receiver, transmission logic, reception logic, etc.), etc.). The present system may be incorporated as a mobile application, i.e. “app” in a mobile device.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Other embodiments and configurations may be devised without departing from the spirit of the invention and the scope of the appended claims.

1. A system for selecting the recommended fitting size of an article of clothing for a user, said article of clothing being a clothing top, comprising:
a) capturing means configured to: 1) obtain a first set of human body dimensions comprising height, weight, and waist size; and, 2) obtain a selected particular article of clothing having a defined set of article dimensions;
b) a first module configured to compute a second set of human body dimensions from said first set of human body dimensions, said first module including a first mathematical model generated by a statistical analysis of a human anthropometric database, wherein said second set of human body dimensions comprises neck size;
c) a second module configured to compute a recommended fitting size based on: 1) said first set of human body dimensions; 2) said second set of human body dimensions; and, 3) said defined set of article dimensions; wherein said second module includes a data base containing article of clothing related look up tables for use in computing said recommended fitting size for said particular article of clothing; and,
d) communication means operatively connected to said second module configured to provide said recommended fitting size to a user.

2. The system of claim 1, wherein said first set of human body dimensions comprises solely height, weight, and waist size.

3. The system of claim 1, wherein said second set of human body dimensions further comprises chest size, shoulder size, stomach size, sleeve size.

4. The system of claim 1, wherein said human anthropometric database comprises the 1988 Anthropometric Survey of U.S. Army Personnel: Methods and Summary Statistics.

5. The system of claim 1, wherein said human anthropometric database comprises the CIVILIAN AMERICAN AND EUROPEAN SURFACE ANTHROPOMETRY RESOURCE (CAESAR).

6. The system of claim 1, further comprising a third module configured to provide at least one redirection option to a user comprising a potential third party affiliate for fulfilling an order.

7. The system of claim 1, further comprising a third module configured to provide at least one redirection option to a user comprising a potential third party affiliate for fulfilling an order, said redirection option being provided simultaneously with said recommended fitting size.

8. The system of claim 1, wherein said capturing means is configured to obtain said first set of human body dimensions and said selected particular article of clothing from an on-line computer, a mobile device, or an in-store device.

9. A system for selecting the recommended fitting size of an article of clothing for a user, said article of clothing being a clothing bottom, comprising:
a) capturing means configured to: 1) obtain a first set of human body dimensions comprising height, weight, and waist size; and, 2) obtain a selected particular article of clothing having a defined set of article dimensions;
b) a first module configured to compute a second set of human body dimensions from said first set of human body dimensions, said first module including a first mathematical model generated by a statistical analysis of a human anthropometric database, wherein said second set of human body dimensions comprises pants size;
c) a second module configured to compute a recommended fitting size based on: 1) said first set of human body dimensions; 2) said second set of human body dimensions; and, 3) said defined set of article dimensions; wherein said second module includes a data base containing article of clothing related look up tables for use in computing said recommended fitting size for said particular article of clothing; and,
d) communication means operatively connected to said second module configured to provide said recommended fitting size to a user.

10. The system of claim 9, wherein said first set of human body dimensions comprises solely height, weight, and waist size.

11. The system of claim 9, wherein said second set of human body dimensions further comprises shoe size and underwear size.

12. The system of claim 9, wherein said human anthropometric database comprises the 1988 Anthropometric Survey of U.S. Army Personnel: Methods and Summary Statistics.

13. The system of claim 9, wherein said human anthropometric database comprises the CIVILIAN AMERICAN AND EUROPEAN SURFACE ANTHROPOMETRY RESOURCE (CAESAR).

14. The system of claim 9, further comprising a third module configured to provide at least one redirection option to a user comprising a potential third party affiliate for fulfilling an order.

15. The system of claim 9, further comprising a third module configured to provide at least one redirection option to a user comprising a potential third party affiliate for fulfilling an order, said redirection option being provided simultaneously with said recommended fitting size.

16. The system of claim 1, wherein said capturing means is configured to obtain said first set of human body dimensions and said selected particular article of clothing from an on-line computer, a mobile device, or an in-store device.

17. A method for selecting the recommended fitting size of an article of clothing for a user, said article of clothing being a clothing top, comprising the steps of:
a) obtaining a first set of human body dimensions comprising height, weight, and waist size;
b) obtaining a selected particular article of clothing having a defined set of article dimensions;
c) computing a second set of human body dimensions from said first set of human body dimensions utilizing a first module, said first module including a first mathematical model generated by a statistical analysis of a human anthropometric database, wherein said second set of human body dimensions comprises neck size;
d) computing a recommended fitting size, utilizing a second module, based on: 1) said first set of human body dimensions; 2) said second set of human body dimensions;
and, 3) said defined set of article dimensions; wherein said second module includes a data base containing article of clothing related look up tables for use in computing said recommended fitting size for said particular article of clothing; and,
e) providing said recommended fitting size to a user utilizing communication means operatively connected to said second module.
